(19) United States
(12) Patent Application Publication
(10) Pub. No.: US 2015/0220663 A1
(43) Pub. Date: Aug. 6, 2015

(54) COMPUTER-INTERACTIVE BUILDING SYSTEM

(71) Applicant: Jonathan Capriola, Sarasota, FL (US)

(72) Inventor: Jonathan Capriola, Sarasota, FL (US)

(21) Appl. No.: 14/612,194

(22) Filed: Feb. 2, 2015

Related U.S. Application Data
(60) Provisional application No. 61/934,108, filed on Jan. 31, 2014.

(51) Int. Cl. G06F 17/50; G06F 13/42; G06F 13/10

(52) U.S. Cl. CPC G06F 17/5004; G06F 13/102; G06F 13/4221

(57) ABSTRACT

A computer-interactive building system includes a plurality of interconnectable blocks, a communications device and a computer. The plurality of interconnectable blocks each have non-transitory memory storing respective block data. The computer executes a software application configured to generate a virtual representation of a physical assembly of at least a portion of the plurality of interconnectable blocks based on the respective block data, and vary at least one attribute of the virtual representation based on a change in the plurality of interconnectable blocks used to make the physical assembly. The communications device is configured for data communication between the at least a portion of the plurality of interconnectable blocks used to the make the physical assembly and the computer.

### CROSS-REFERENCE TO RELATED APPLICATION

This application claims the benefit of U.S. Provisional Patent Application Ser. No. 62/934,108, filed on Jan. 31, 2014, the contents of which are herein incorporated by reference in their entirety.

### FIELD OF THE INVENTION

The present invention relates to toy building systems, and more particularly, to toy building systems utilizing a plurality of powered blocks.

### BACKGROUND OF THE INVENTION

Various toy building systems have been developed that seek to give the user a greater range of building options, and correspondingly a greater outlet for his or her imagination and creativity. One direction taken by these developments has been the inclusion of one or more powered blocks in the building system, which gives the user the ability to add powered functions like light, sound and motion into a completed assembly.

In parallel with these developments in physical toy building systems, software applications have been developed that allow a user to construct a “virtual” model. Because virtual models are not constrained by the same physical limitations as real-world toy models, such software applications can allow more flexibility in the construction and manipulation of models. However, a virtual model naturally lacks the tangibility of a physical model and the multi-sensory interactivity and stimulation attendant on actually building something. Hence, physical toy building systems remain extremely popular despite their limitations relative to computer-based model building.

### SUMMARY OF THE INVENTION

In view of the foregoing, it is an object of the present invention to provide a computer-interactive building system, which combines the fun and satisfaction of building a physical model with the less constrained possibilities of a virtual model.

According to an embodiment of the present invention, a computer-interactive building system includes a plurality of interconnectable blocks, a communications device and a computer. The plurality of interconnectable blocks each have non-transitory memory storing respective block data. The computer executes a software application configured to generate a virtual representation of a physical assembly of at least a portion of the plurality of interconnectable blocks based on the respective block data, and vary at least one attribute of the virtual representation based on a change in the plurality of interconnectable blocks used to make the physical assembly. The communications device is configured for data communication between the at least a portion of the plurality of interconnectable blocks used to the make the physical assembly and the computer.

According to an aspect of the present invention, mechanical connections are made between the blocks with universal serial bus (USB) connectors, such as micro-USB connectors. According to another aspect, the communications device can be integrated into one or more of the blocks and/or into a power base module on which the blocks are assembled. Communications between the communications device and the computer can be via wireless and/or physical connections.

According to a further aspect, the attribute varied based on a change in the blocks used in the physical assembly includes at least one of an appearance of the virtual representation, a playable characteristic of the virtual representation, and an access characteristic of the virtual representation. Advantageously, more than one attribute can be varied when a block is added or removed from the physical assembly.

According to an additional aspect, one or more of the plurality of the blocks can include powered elements, such as visible, audible and/or movable elements. These powered elements could also be activated/operated by the software application via the communications device.

These and other objects, aspects and advantages of the present invention will be better appreciated in view of the drawings and following detailed description of preferred embodiments.

### BRIEF DESCRIPTION

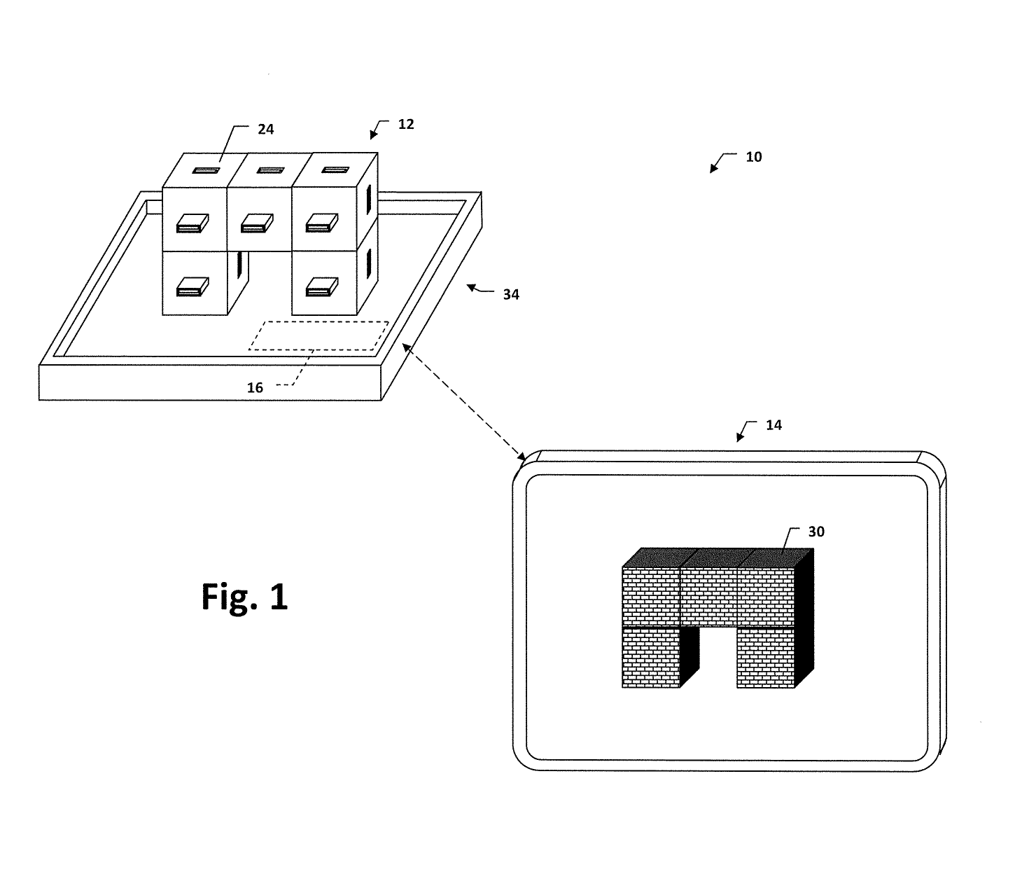

FIG. 1 is a schematic perspective view of a computer-interactive building system, according to an embodiment of the present invention;

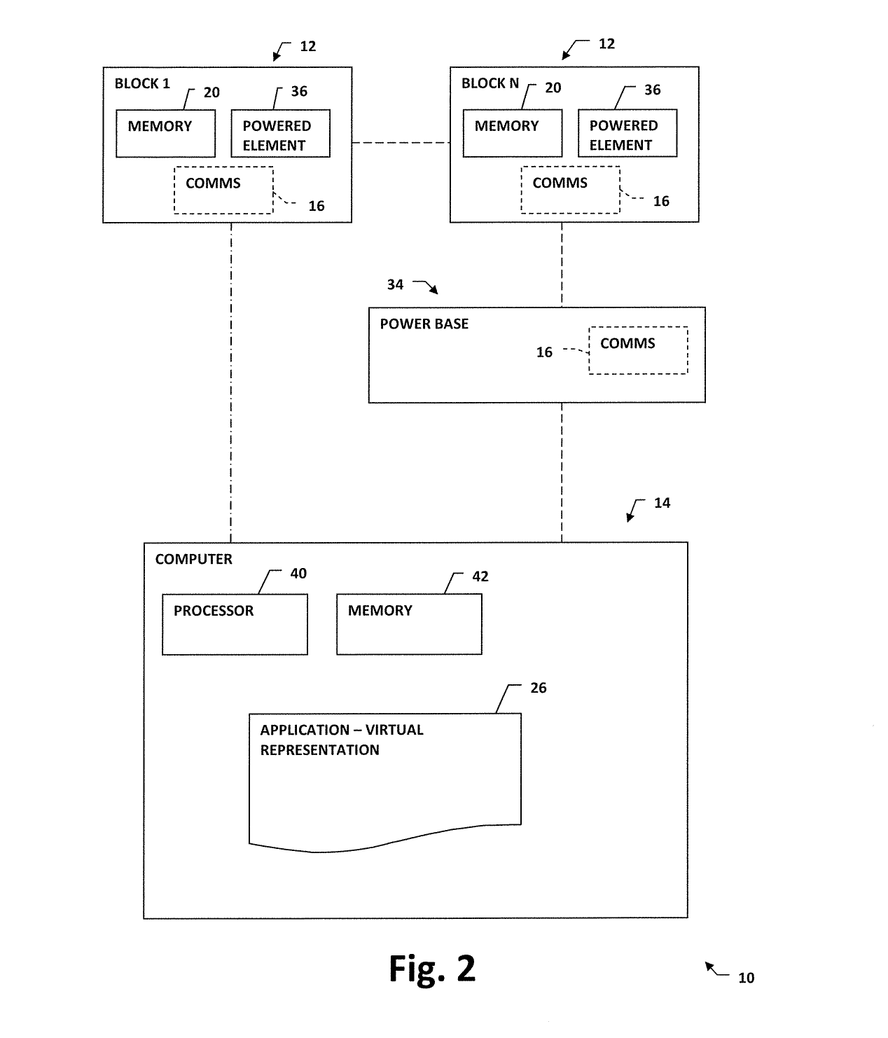

FIG. 2 is a schematic organizational overview of the system of FIG. 1; and

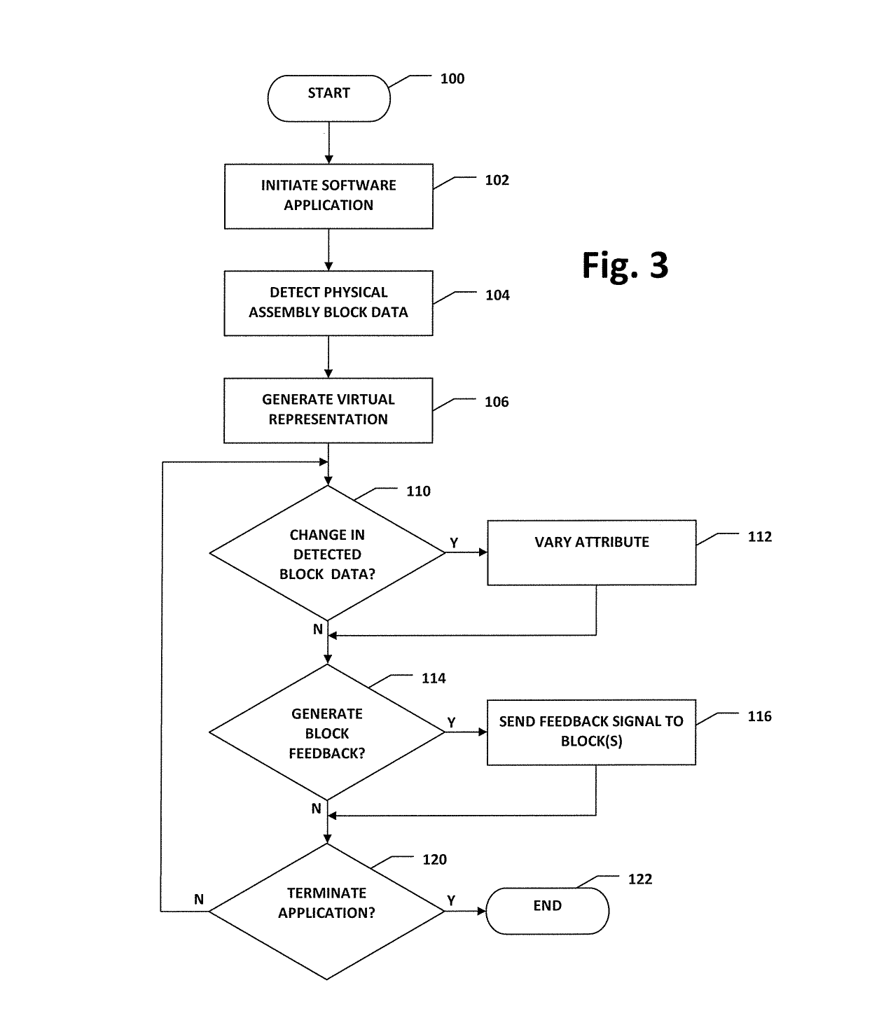

FIG. 3 is a flow diagram of operations of the system of FIG. 1.

### DETAILED DESCRIPTION OF PREFERRED EMBODIMENTS

Referring to FIGS. 1 and 2, a computer-interactive building system 10 includes a plurality of interconnectable blocks 12, a computer 14 and a communications device 16. Each of the blocks 12 has non-transitory memory 20 storing respective block data, and all or a portion of the blocks 12 can be connected to form a physical assembly 24. The computer 14 executes a software application 26 configured to generate a virtual representation 30 of the physical assembly 24 based on the respective block data of the blocks 12 used in the physical assembly 24. The software application 26 is further configured to vary at least one attribute of the virtual representation 30 based on a change in the blocks 12 used to make the physical assembly 24.

As used herein, the term “block” should be understood to generally refer to a toy construction element, and is not necessarily limited to any particularly shape. For example, the blocks could be a variety of body parts connectable to form one or more human, animal or imagined (e.g., mythical creatures, monsters) figures, along with blocks constituting clothing or accessories therefor (e.g., backpacks, hats). In another example, blocks could be given shapes suitable for forming a vehicle (e.g., cars, boats, planes, rockets) or buildings (e.g., castles, houses, offices).

The mechanical and data interconnectivity of the blocks 12 is preferably achieved using the same connectors; for instance, universal serial bus (USB) connectors. Any size of USB connectors could be employed, with micro-USB connectors being preferably for many embodiments. More than one connector size or format could also be employed within a given set of blocks 12.

Alternately, separate “dumb” mechanical connectors for the blocks 12 could be independent of data connections. A “hybrid” connection could be employed, wherein data was not carried over the mechanical connectors, but making the mechanical connection triggers the transmission of data from the block 12 to the communications device 16 via other means (e.g., wirelessly).

A flash memory drive is preferred for the non-transitory memory 20, although other types memory hardware could be employed. “Non-transitory memory,” as used herein, should be understood to refer to the hardware for memory storage and not merely a transient energy state maintained by such hardware. The present invention is not necessarily limited to any particular format for encoding the respective block data. The block data stored in memory 20 can be read-only, or rewritable during use. Additionally, the inclusion of a plurality of interconnectable blocks 12 with communicable memory 20 in the system 10 does not preclude the inclusion of additional interconnectable blocks, either powered or unpowered, that are unable to communicate block data.

One or more of the blocks 12 could have a communications device 16 integrated therein, such that the respective block data could be communicated directly to the computer 14. Alternately, the blocks 12 could be assembled on a power base 34 that incorporates a communications device 16.

The communications device 16 could be adapted for wired connection; for instance, using a USB cable that plugged into a USB connector on the computer 14, in which electrical power could also be drawn from the data connection. Alternately, another power source could be provided and the communications device 16 could communicate wirelessly with the computer 14. Preferably, only a single one of the blocks 12 needs to be connected to electrical power and/or the data connection, with the remainder of the blocks 12 in the assembly 24 receiving power and communicating data via intermediate connected blocks 12.

Electrical power for operating one or more powered elements 36 (in addition to the memory 20) in the blocks 12 could also be drawn from the data connection with the computer 14, and then relayed through all connected blocks in the assembly 24. Advantageous examples of powered elements 36 include visible (e.g., lights, video displays), audible (e.g., buzzers, speakers) and/or movable (e.g., solenoids, motors) elements. The presence of powered elements 36 could be represented in the respective block data, and the software application 26 could be further configured to selectively operate the powered elements 36 via the communications device 16.

The computer 14 includes at least one processor 40 and non-transistory memory 42 for executing the software application 26. As used herein, the term “computer” should be understood to refer generally to any microprocessor-based computer device capable of receiving data inputs and generating display and other data outputs. Non-limiting examples include desktop computers, laptop computers, and video game consoles, as well as tablet computers, “smart” phones and other personal electronic devices. The present invention is not necessarily limited to any particular number of processors or memory devices, nor to particular data formats or programming languages. For example, functions of the computer 14 could be executed over a network by geographically distant from each other and from the user.

Referring to FIG. 3, an implementation method using the software application 26 executed by the computer 14 begins at step 100. At step 102, the software application 26 is initiated by the computer 14. This could be accomplished by a user manually selecting the application, or the application could be automatically initiated upon receipt of initial communications from the communications device 16. Exemplary software applications 26 executed in connection with the present invention include educational and entertainment software, such as video games; however, the present invention is not necessarily limited thereto.

At step 104, physical assembly 24 block data is detected. In one implementation, the computer 14 receives the respective block data from the communications device, which indicates what blocks 12 are connected in the physical assembly 24, as well as in what configuration. With the information from step 104, the virtual representation 30 of the physical assembly 24 is generated. The degree of resemblance between the blocks 12 in the physical assembly 24 and their virtual representation 30 might differ greatly in different implementations of the invention. For instance, some virtual representations might be very accurate reproductions of the blocks 12, whereas others might add additional surface textures and soften edges for a more life-like appearance, and still others might bear no resemblance to the physical blocks 12.

Additionally, the virtual representation 30 may be placed in some virtual environment. A user could be allowed to move the virtual representation through the environment; for instance, using a mouse, game controller or other input device. The user could also zoom in and out and view the virtual representation from different positions/angles.

At step 110, any changes in block data are detected; for example, changes resulting from the addition or removal or one or more blocks 12 from the assembly 24. If changes are detected, at least one attribute of the virtual representation is changed at step 112. Variable attributes advantageously include appearance, “playable” characteristics, and access characteristics.

When appearance is changed by the addition or removal of a block 12, the virtual representation 26 is graphically updated. Animations can be used to the enhance the change in appearance. For example, a wheel removed from a physical assembly 24 can be shown to roll away from a vehicle depicted in the virtual representation. A hat or backpack added to the physical assembly 24 can “fly-in” onto a figure depicted in the virtual representation.

When a “playable” characteristic is changed (effectively, a change which alters the manner in which the user can interact with and in the virtual environment through the virtual representation), some cue indicating the announcement can be made. Examples of variable playable characteristics can include varying the speed (e.g, allowing the representation to move faster or slower), strength (e.g., allowing a character to lift more or a vehicle to pull more), endurance (e.g., giving a character more “life”), enhanced sense (e.g., changing how far a character can see, wavelengths of light that can be perceived, sounds that can be heard), armament (e.g., in a shooter style game, the types of “attacks” or “defenses” that could be employed), and movement mode (e.g., ability to fly, swim, jump high).

“Access” characteristics allow changes in access to the virtual environment by the virtual representation 30. For example, a new level could be unlocked, a new location could be opened for exploration, or a game within a game (e.g., a “mini game”) could be unlocked.

Advantageously, more than one attribute could be varied simultaneously. For example, if a rocket pack block is added to a physical assembly 30, the virtual representation 30 appearance would be changed to depict the rocket pack on the back of a figure, that would also gain the ability to fly, and be permitted to participate in a special mini game involving the use of the rocket pack.

At step 114, it is determined whether any block feedback should be generated, with feedback signals being generated if appropriate (step 116). For instance, if one of the blocks 12 includes a speaker, the application 26 could direct the playing of a “revving” sound if a virtual representation 30 of a car raced its engine, or a “yawn” if a virtual representation 30 of a figure was tired. Lights could be flashed in a block 12 equipped therewith if the virtual representation 30 of a wall was illuminated. Additionally, if any blocks 12 are equipped with reprogrammable memory 20, block data customization could be permitted, with users able to associate special attributes with programmable blocks.

The foregoing steps would be reiterated in any logical order while the software application 26 continued to run at step 120. If the application was terminated, then the method would end at step 122.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is claimed is:

1. A computer-interactive building system comprising:
a plurality of interconnectable blocks, each of the plurality of interconnectable blocks having non-transitory memory storing respective block data;
a computer executing a software application configured to:
generate a virtual representation of a physical assembly of at least a portion of the plurality of interconnectable blocks based on the respective block data of the at least a portion of the plurality of interconnectable blocks used to make the physical assembly; and
vary at least one attribute of the virtual representation based on a change in the at least a portion of the plurality of interconnectable blocks used to make the physical assembly; and
a communications device configured for data communication between the at least a portion of the plurality of interconnectable blocks used to the make the physical assembly and the computer.

2. The system of claim 1, wherein each of the plurality of interconnectable blocks is configured such that a mechanical connection with another of the plurality of interconnectable blocks in the physical assembly allows data transfer therebetween.

3. The system of claim 2, wherein each of the plurality of interconnectable blocks includes at least one universal serial bus (USB) connector.

4. The system of claim 3, wherein the at least one USB connector is a micro-USB connector.

5. The system of claim 1, wherein the communications device is integrated into at least one of the plurality of interconnectable blocks.

6. The system of claim 1, further comprising a power base module, wherein the communications device is integrated thereinto.

7. The system of claim 6, wherein a data connection between the power base module and the physical assembly is a physical connection.

8. The system of claim 6, wherein a data connection between the power base module and the physical assembly is a wireless connection.

9. The system of claim 1, wherein the communications device is configured for wireless communication with the computer.

10. The system of claim 1, wherein the communications device is configured for wired communication with the computer.

11. The system of claim 10, wherein the communications device plugs into a universal serial bus (USB) connector of the computer.

12. The system of claim 1, wherein the at least one attribute of the virtual representation varied by the software application based on the change in the at least a portion of the plurality of interconnectable blocks used to make the physical assembly includes at least one of: an appearance of the virtual representation, a playable characteristic of the virtual representation, and an access characteristic of the virtual representation.

13. The system of claim 12, wherein the at least one attribute of the virtual representation varied by the software application based on the change in the at least a portion of the plurality of interconnectable blocks used to make the physical assembly includes the appearance of the virtual representation, and also at least one of: the playable characteristic of the virtual representation, and the access characteristic of the virtual representation.

14. The system of claim 12, wherein the at least one attribute of the virtual representation varied by the software application based on the change in the at least a portion of the plurality of interconnectable blocks used to make the physical assembly includes the playable characteristic of the virtual representation, the playable characteristic including at least one of: speed, strength, endurance, enhanced sense, armament, and movement mode.

15. The system of claim 12, wherein the at least one attribute of the virtual representation varied by the software application based on the change in the at least a portion of the plurality of interconnectable blocks used to make the physical assembly includes the access characteristic of the virtual representation, the access characteristic including at least one of: unlocking of a new level, unlocking of a new location, and unlocking of game within a game.

16. The system of claim 1, further comprising:
a power base module supplying power to the physical assembly;
wherein at least one of the plurality of interconnectable blocks includes a powered element powered by the power base module when the at least one of the plurality of interconnectable blocks is connected to the physical assembly.

17. The system of claim 16, wherein the at least one powered element includes at least one of: a visible element, an audible element, and a movable element.

18. The system of claim 16, wherein the software application is further configured to activate the at least one powered element via the communications device.

19. The system of claim 1, wherein the software application is configured to alter the respective block data of at least one of the plurality of blocks used in the physical assembly via the communications device.

20. A computer-interactive building system kit comprising:
a plurality of interconnectable blocks, each of the plurality of interconnectable blocks having non-transitory memory storing respective block data;
a non-transitory memory storage device comprising program instructions for executing a software application when loaded on a computer, the software application as executed by the computer being configured to:
generate a virtual representation of a physical assembly of at least a portion of the plurality of interconnectable blocks based on the respective block data of the at least a portion of the plurality of interconnectable blocks used to make the physical assembly; and
vary at least one attribute of the virtual representation based on a change in the at least a portion of the plurality of interconnectable blocks used to make the physical assembly; and
a communications device configured for data communication between the at least a portion of the plurality of interconnectable blocks used to the make the physical assembly and the computer.
